(19) United States
(12) Patent Application Publication
(10) Pub. No.: US 2025/0312721 A1
(43) Pub. Date: Oct. 9, 2025

(54) Smoke Plume Capture

(71) Applicant: Vanalay US Inc, Sarasota, FL (US)

(72) Inventor: Andrew Barrows, Bradenton, FL (US)

(21) Appl. No.: 19/169,393

(22) Filed: Apr. 3, 2025

Related U.S. Application Data
(60) Provisional application No. 63/573,712, filed on Apr. 3, 2024.

(51) Int. Cl. B01D 46/10; B01D 46/00; B01D 46/42

(52) U.S. Cl. CPC B01D 46/10; B01D 46/0047; B01D 46/42; B01D 2201/34; B01D 2221/02

(57) ABSTRACT

A smoke plume capture device includes a treatment portion having a sidewall extending from a distal end that is configured to contact a surface of a treatment area to a proximal end. The treatment portion defines a treatment cavity and the sidewall defines a plurality of venting apertures opening into the treatment cavity. The capture device also includes a coupling portion extending from the proximal end of the treatment portion, the coupling portion configured to removably couple to a treatment device. The capture device also includes an evacuation portion defining a lumen fluidly coupled to the treatment cavity. The evacuation portion is configured to removably and fluidly couple to an evacuation device configured to draw fresh air from outside of the treatment area through the plurality of venting apertures, across the treatment area, and out the lumen of the evacuation portion.

### CROSS REFERENCE TO RELATED APPLICATION

This patent application claims the benefit of U.S. Provisional Application No. 63/573,712 titled SMOKE PLUME CAPTURE, filed Apr. 3, 2024, the content of which is expressly incorporated by reference herein in its entirety.

### TECHNICAL FIELD

The present disclosure is directed to articles, systems, and methods providing for the containment and capture of a smoke plume produced during the application of radiation from a radiation source to a surface for the removal of a biological material or a non-biological material.

### BACKGROUND

Radiation controllably emitted from a treatment device may be used to remove biological or other materials from a surface of a treatment site. The radiation may include a selected wavelength range, such as a range in the ultraviolet (UV) spectrum. Such devices may be used to treat the skin in mammals. For example, a treatment device may direct UV radiation toward skin of a patient to remove material at, near, or within the skin, such as for example, hair, debris, scar tissue, tattoo ink or other foreign matter. Removal may be caused, at least in part, by heating or burning of the material or matter around the material. The heating or burning of the material or matter around the material may generate smoke or other airborne particulate matter. The smoke produced during these procedures may be harmful to clinicians or patients. Therefore, there is a need to control particulate matter or smoke emitted from a treatment site.

### SUMMARY

The present disclosure describes systems and methods having a smoke plume capture device that couples to a treatment device and a smoke evacuation device. The capture device surrounds a radiation emitting portion of the treatment device. The capture device may be transparent to visible light to enable an operator to visualize the treatment area and/or may be configured to block a selected wavelength of radiation, such as an ultraviolet wavelength or the like. The treatment device may include, for example, laser devices, broadband light devices, hyfrecator devices, or the like. The treatment device may include a handheld device.

The radiation emitting portion is configured to direct radiation toward a treatment area to remove a material at the treatment area, emitting at least some particulate matter as smoke during the treatment. The capture device is fluidly coupled to the smoke evacuation device to draw a vacuum at the treatment area. The capture device may define apertures configured to direct fresh air flow toward the treatment area during the evacuation of the smoke, which may cool the treatment area and/or provide a selected fluid flow at or near the treatment area to direct the smoke in a predetermined flow path toward the smoke evacuation device. The capture device may include a filter in at least a portion of the flow path, such that the filter is configured to capture at least a portion of the particulate matter during the treatment. Additionally, or alternatively, the smoke evacuation device may be configured to capture at least the particulate matter of the smoke generated during the treatment.

By surrounding the radiation emitting portion, the capture device is configured to reduce a smoke plume by encapsulating the treatment area, evaluating the smoke, and capturing the smoke. Additionally, by coupling to each of the treatment device and the smoke evacuation device, the capture device may enable single-hand operation of the treatment device.

In some examples, the disclosure describes a smoke plume capture device including a treatment portion, a coupling portion, and an evacuation portion. The treatment portion includes a sidewall extending from a distal end that is configured to contact a surface of a treatment area to a proximal end. The sidewall of the treatment portion defines a treatment cavity and a plurality of venting apertures opening into the treatment cavity between the distal end and the proximal end. The coupling portion extends from the proximal end of the treatment portion and is configured to removably couple to a treatment device. The evacuation portion defines a lumen fluidly coupled to the treatment cavity and is configured to removably and fluidly couple to an evacuation device configured to draw fresh air from outside of the treatment area through the plurality of venting apertures, across the treatment area, and out the lumen of the evacuation portion.

In some examples, the disclosure describes a system that includes the above-described smoke plume capture device. The system also includes a treatment device and an evacuation device.

In some examples, a method of capturing particulates produced at a surface of a treatment area in response to incident radiation is described. The method includes coupling the above-described smoke plume capture device to a treatment device. The method also includes coupling the smoke plume capture device to an evacuation device. The method further includes contacting the distal end of the treatment device with the surface of the treatment area, controlling the treatment device to direct radiation toward the treatment area, and controlling the evacuation device to draw fresh air from outside of the treatment area through the plurality of venting apertures, across the treatment area, and out the lumen of the evacuation portion.

In some examples, the disclosure describes a smoke plume capture device for coupling to a treatment device and a smoke evacuation device. The capture device surrounds a radiation emitting portion of the treatment device. The capture device is fluidly coupled to the smoke evacuation device to draw a vacuum at the treatment area. The capture device defines apertures configured to direct fresh air flow toward the treatment area to cool the treatment area and direct smoke from the treatment area in a predetermined flow path toward the smoke evacuation device. The capture device may include a filter in at least a portion of the flow path, the filter configured to capture at least a portion of a particulate matter of the smoke.

In some examples, the disclosure describes a system for capturing particulates produced at a surface of a treatment area in response to incident radiation including a treatment device, a smoke evacuation device, and a smoke plume capture device. The treatment device is configured to direct radiation having a selected wavelength range toward a treatment area. The smoke evacuation device is configured to draw smoke away from the treatment area along a flow path and contain or filter at least one constituent from the smoke. The smoke plume capture device is coupled to the treatment device and the smoke evacuation device. The capture device surrounds a radiation emitting portion of the treatment device. The capture device defines a plurality of apertures configured to direct fresh air flow toward the treatment area during evacuation of the smoke. The capture device may include a filter disposed in at least a portion of the flow path and configured to capture at least a portion of the at least one constituent from the smoke.

In some examples, the disclosure describes a method for capturing particulates produced at a surface of a treatment area in response to incident radiation, comprising the steps of: providing a smoke plume capture device that couples to a treatment device and a smoke evacuation device; surrounding a radiation emitting portion of the treatment device with the capture device, wherein the capture device may be transparent to visible light or configured to block a selected wavelength of radiation; directing radiation toward the treatment area using the radiation emitting portion to remove a material at the treatment area and emit smoke as a byproduct; drawing a vacuum at the treatment area using the capture device, which may comprise defining apertures to direct fresh air flow toward the treatment area during evacuation of the smoke or comprising a filter in at least a portion of the flow path to capture particulates; and capturing the smoke using the smoke evacuation device.

### BRIEF DESCRIPTION OF THE DRAWINGS

The disclosure can be understood in consideration of the following detailed description of various embodiments in connection with the accompanying drawings.

FIG. 1 is a conceptual diagram illustrating an example system configured to capture particulates produced at a surface of a treatment area in response to incident radiation.

FIG. 2 is a conceptual diagram illustrating a bottom view of the capture device of the system illustrated in FIG. 1.

FIG. 3 is a conceptual diagram illustrating an example capture device having apertures configured to induce a vortex motion of fluid within a treatment area.

FIG. 4 is a conceptual diagram illustrating an example smoke plume capture system for use with a hyfrecator pencil.

FIG. 5 is a conceptual diagram illustrating an example smoke plume capture system for use with a broadband light handpiece.

FIG. 6 is a conceptual diagram illustrating an example smoke plume capture system for use with a laser handpiece.

FIGS. 7A and 7B are diagrams illustrating an example smoke plume capture system.

### DETAILED DESCRIPTION

For purposes of promoting an understanding of the principles of the disclosure, reference will now be made to the embodiments illustrated in the drawings, and specific language will be used to describe the same. It will nonetheless be understood that no limitation of the scope of the disclosure is intended by the illustration and description of certain embodiments of the disclosure. In addition, any alterations and/or modifications of the illustrated and/or described embodiment(s) are contemplated as being within the scope of the present disclosure. Further, any other applications of the principles of the disclosure, as illustrated and/or described herein, as would normally occur to one skilled in the art to which the disclosure pertains, are contemplated as being within the scope of the present disclosure.

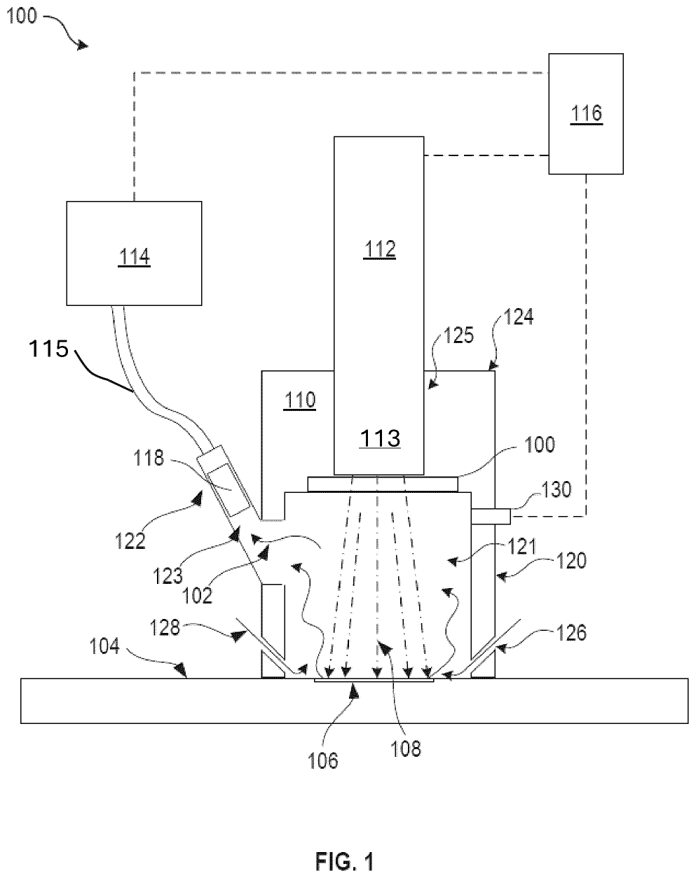

FIG. 1 is a conceptual diagram illustrating an example smoke plume capture system 100. System 100 is configured to capture particulates or other constituents of smoke 102 produced at a surface 104 of a treatment area 106, such as at a surface of a patient's skin, in response to incident radiation 108. System 100 includes a capture device 110, a treatment device 112, an evacuation device 114, and an optional controller 116.

Capture device 110 is configured to contain smoke 102 produced during a treatment and enable evacuation device 114 to draw smoke 102 away from treatment area 106. Capture device 110 includes a treatment portion 120 configured to create a seal around treatment area 106, an evacuation portion 122 fluidly coupled to evacuation device 114, and a coupling portion 124 removably coupled to treatment device 112.

In some examples, capture device 110 may include a filter 118 disposed in evacuation portion 122. Filter 118 may include an optionally disposable prefilter before further filtration within evacuation device 114. For example, filter 118 may include a fiber filter, such as a cotton filter or a synthetic fiber filter.

Treatment portion 120 includes a sidewall extending from a distal end that is configured to contact surface 104 of treatment area 106 to a proximal end. Treatment portion 120 defines a treatment cavity 121. Sidewall defines a plurality of venting apertures 126 between the distal end and the proximal end. During operation, fresh air 128 may be drawn through apertures 126 by a vacuum generated by evacuation device 114. For certain types of treatment, using suction at the skin, as generated by the vacuum effect of evacuation device 114, can enhance laser efficacy.

Evacuation portion 122 defines a lumen 123 fluidly coupled to treatment cavity 121. Evacuation portion 122 is configured to removably and fluidly couple to evacuation device 114 and configured to draw fresh air 128 from outside of treatment area 106 through venting apertures 126, across treatment area 106, and out lumen 123 of evacuation portion 122. In some examples, filter 118 may be fitted within at least a portion of lumen 123. Lumen 123 and venting apertures 126 may be relatively positioned to cause, in response to a vacuum pulled by evacuation device 114, a selected flow path of fluid from and through venting apertures 126, into chamber 121, across the skin surface and to lumen 123. The selected flow path may be configured to cool treatment area 106, facilitate drawing of smoke 102 from treatment cavity 121, or both.

Coupling portion 124 extends from the proximal end of treatment portion 120. In some examples, coupling portion 124 and treatment portion 120 may define a unitary component. Coupling portion 124 is configured to removably couple to treatment device 112. For example, coupling portion 124 may define a treatment device cavity 125 configured to receive therein treatment device 112 in a friction fit. In some examples, coupling portion 124 may be configured to protect at least a portion of treatment device 112 from contamination with material released during operation, such as smoke 102, by defining a barrier at the portion of treatment device 112.

Controller 116 may be communicatively coupled to treatment device 112, evacuation device 114, and an optional sensor 130. Controller 116 is configured to control and/or monitor an operation of treatment device 112, evacuation device 114, and optional sensor 130. For example, controller 116 may only enable operation of treatment device 112 when evacuation device 114 is operating, thereby ensuring that smoke 102 is contained by system 100. Additionally, or alternatively, a power state of evacuation device 114 (e.g., controlling how much fluid is drawn through treatment cavity 121) may be based, at least in part, on a power state of treatment device 112 (e.g., an amount of radiation emitted by treatment device, which may be correlated to an amount or type of smoke 102 produced during treatment). In some examples, sensor 130 may be configured to monitor a temperature, pressure, or particular count within treatment cavity 121. Controller 116 may determine, based on the monitored temperature, pressure, or particular count, an operation of either or both of treatment device 112 and evacuation device 114. For example, a monitored temperature exceeding a threshold temperature may cause controller 116 to suspend operation of treatment device 112, a monitored pressure exceeding a threshold pressure may cause controller 116 to system operation of treatment device 112 and/or increase a vacuum produced by evacuation device 114, a monitored particular count exceeding a threshold particulate count may cause controller 116 to system operation of treatment device 112 and/or increase a vacuum produced by evacuation device 114, or the like.

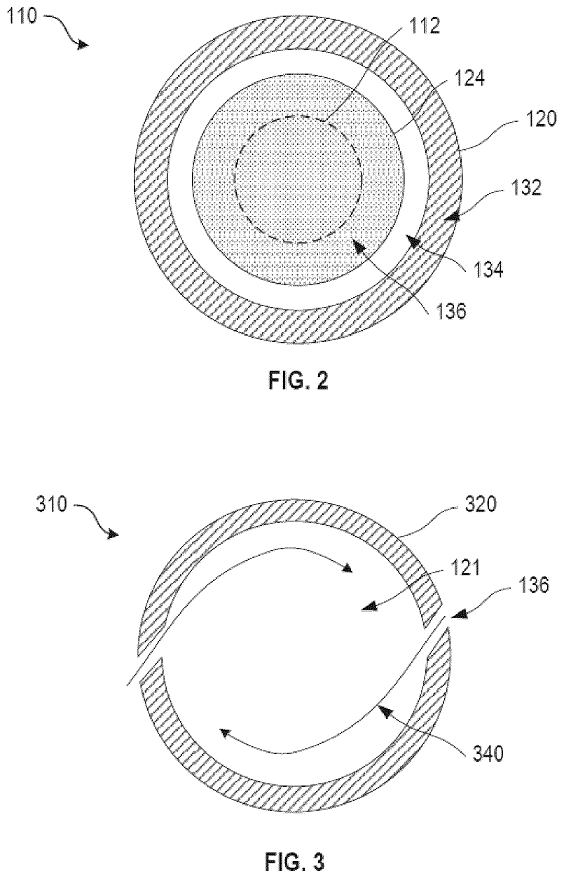

FIG. 2 is a conceptual diagram illustrating a bottom view of capture device 110 of system 100 illustrated in FIG. 1. As illustrated in the bottom view, capture device 110 includes treatment portion 120 extending from a distal end 132 (configured to contact surface 104) to a proximal end 134 coupled to coupling portion 124. Coupling portion 124 (or alternatively, treatment portion 120) may define a separation layer 136 configured to physically separate treatment device 112 from treatment cavity 121.

FIG. 3 is a conceptual diagram illustrating an example treatment portion 320 of a capture device 310 having apertures 326 configured to induce a vortex motion 340 of fluid within a treatment area or treatment cavity 321. Treatment portion 320 may be the same or substantially similar to treatment portion 129 described above in reference to FIGS. 1 and 2.

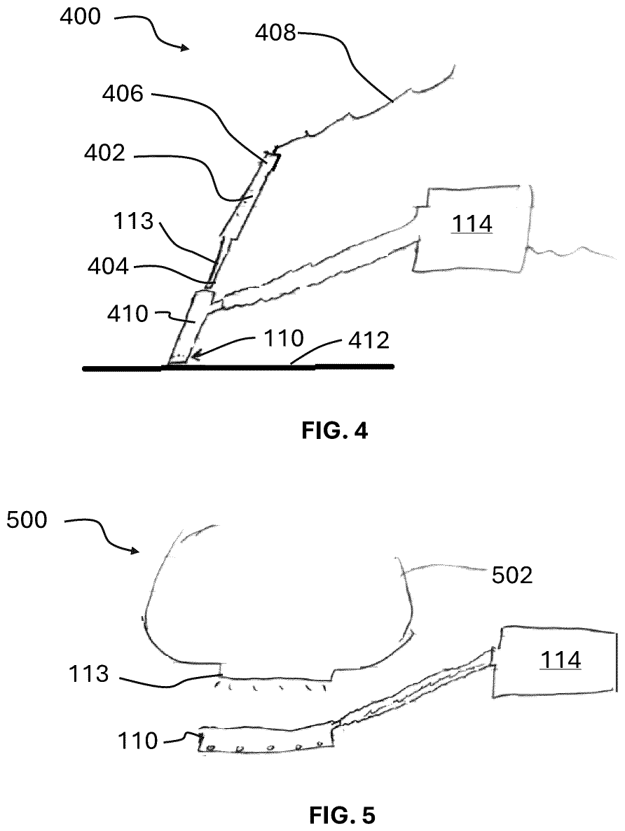

FIG. 4 is a conceptual diagram illustrating an example smoke plume capture system 400 configured for use with a hyfrecator device 402, which may be a hyfrecator pencil 402, having first or applicator end 404 with radiation-emitting portion 113, and second end 406 with power cord 408. System 400 may be the same as or substantially similar to system 100 described above in reference to FIGS. 1 and 2, though configured for use with hyfrecator device 402, as further described below.

In the embodiment of FIG. 4, and also referring to FIG. 1, treatment device 112 is a hyfrecator device 402; capture device 110 may define a relatively narrow tubular channel 410 configured to receive applicator end 404, such that applicator end 404 may be located at or near skin surface 412. Evacuation device 114 is communicatively coupled to capture device 110, as also described with respect to FIGS. 1-3, to evacuate particulate matter generated when hyfrecator device 402 is used to destroy or modify skin tissue via electrical power.

FIG. 5 is a conceptual diagram illustrating an example smoke plume capture system 500 for use with a broadband light handpiece 502 serving as a treatment device 112, configured to emit intense pulsed light (IPL) for hair removal and other cosmetic treatments. System 500 may be the same or substantially similar to system 100 described above in reference to FIGS. 1 and 2, with capture device 110 configured to receive a portion of broadband light handpiece 502 and in some embodiments, seal with broadband light handpiece 502.

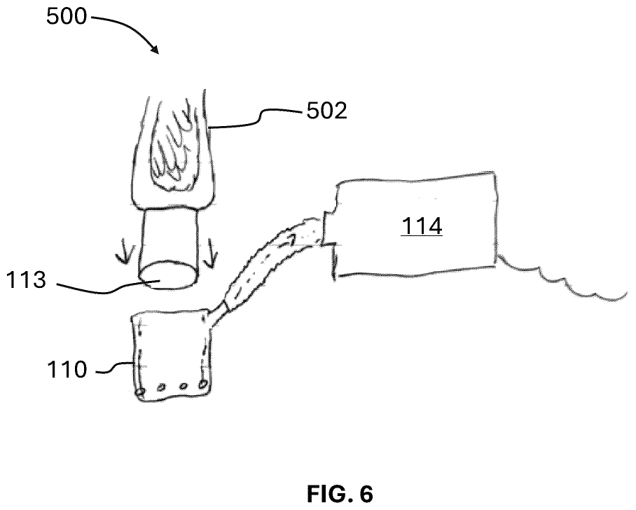

FIG. 6 is a conceptual diagram illustrating an example smoke plume capture system 600 for use with a laser handpiece 602. System 600 may be the same or substantially similar to system 100 described above in reference to FIGS. 1 and 2 with capture device 110 configured to receive a portion of laser-light handpiece 602 emitting laser light. Similar to other embodiments smoke capture device 110 is sized and shaped to fit to the treatment device, which in this embodiment, is a laser handpiece 602.

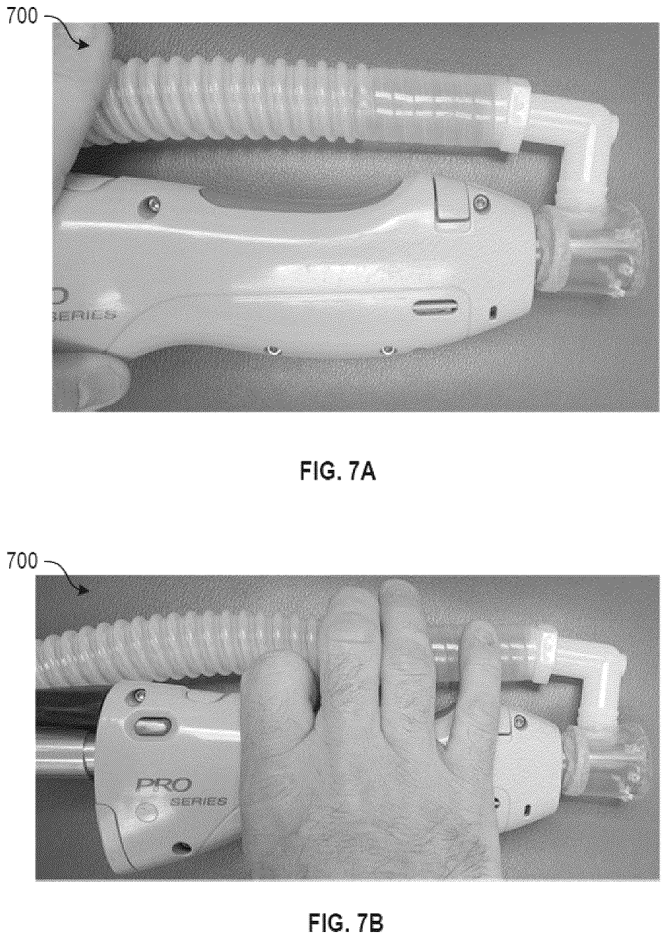

FIGS. 7A and 7B are diagrams illustrating an example smoke plume capture system 700. System 700 may be the same or substantially similar to system 100 described above in reference to FIGS. 1 and 2.

Although the system of the present disclosure is generally directed to use with medical treatments, in other embodiments, systems and devices may be adapted for use for capturing smoke plumes and particulates in other applications, such as paint or mold removal from objects. In one such embodiment, systems and devices described herein may capture paint smoke and particulars, particularly lead paint, thereby minimizing or preventing lead from being released into the environment. Consequently, embodiments of the present disclosure include laser cleaning devices that are used to clean mold, leaded paint or other such materials. These substances can be toxic and can become airborne. Systems and devices of the disclosure utilizing the suction effect will eliminate such toxic materials from becoming airborne or getting into the environment.

Referring to FIGS. 1-7B, the below examples are applicable to the smoke plume capture systems 100-700 described herein.

The capture device 110 is a useful component of the smoke plume capture system that surrounds the radiation emitting portion 113 of the treatment device 112, reducing the amount of smoke or smoke plume generated during treatment and improving overall efficiency. The materials used for construction can vary depending on specific requirements, but suitable options include elastomeric materials, high-density polyethylene (HDPE), polytetrafluoroethylene (PTFE), or silicone. These materials should possess properties such as durability, resistance to chemicals and radiation, and flexibility to accommodate different shapes and sizes of treatment devices 112.

The capture device 110 ensures a secure and airtight seal around the radiation emitting portion 113 by creating a tight fit between the capture device 110 and the treatment device 112. The seal between the capture device 110 and treatment device 112 may reduce the risk of leakage or airborne contamination. To address these concerns, it may be valuable to follow proper protocols for handling and disposal of the capture device 110, ensure proper training and use by medical personnel, and use appropriate personal protective equipment (PPE) as needed.

The capture device 110 can be adjusted to accommodate different sizes or shapes of radiation emitting portions 113 of various treatment devices 112. This can be accomplished by designing the capture device 110 with interchangeable components or using modular systems that allow for customization. The maximum amount of smoke that can be captured by the capture device 110 before it becomes useful to empty or replace the filter 118 will depend on several factors, including the size and efficiency of the filter 118, the volume of smoke generated during treatment, and the duration of the procedure. In general, the filter 118 should be replaced after each treatment procedure or when it becomes saturated with smoke or when it functionally reduces the flow rate of air through the capture device 110.

The capture device 110 can work in conjunction with other medical devices or equipment, such as suction catheters and so on, to enhance the efficiency of treatment procedures by capturing and removing smoke generated during suctioning or providing a barrier between delicate tissues and potential contaminants during surgery. Some safety concerns associated with using the smoke plume capture device 110 include the risk of inhalation of smoke, exposure to chemicals or radiation, and potential damage to delicate tissues during treatment. These risks can be mitigated by following proper protocols for handling and disposal of the capture device 110, ensuring proper training and use of the device by medical personnel, and using appropriate personal protective equipment (PPE) as needed.

The capture device 110 is configured to work with different types of radiation emitting portions 113, such as those using different wavelengths or energy levels. This may require modifications to the filter 118 or other components of the capture device 110 to ensure proper filtration and capture of the specific type of smoke generated by the treatment device 112. Additionally, or alternatively, the material of the capture device 110 may be selected for compatibility with the different types of radiation.

The treatment device 112 is a useful component of the smoke plume capture system, as it emits radiation that removes material from the treatment area while generating smoke and/or particulate matter. The radiation emitting portion 113 of the treatment device 112 can vary depending on the specific application and type of radiation used. For instance, laser devices, broadband light devices, and hyfrecator devices are examples of treatment devices 112 that emit different types of radiation. To ensure a secure and airtight seal around the radiation emitting portion 113, the capture device 110 is configured to create a tight fit between itself and the treatment device 112. This design feature helps to reduce smoke plumes by encapsulating the treatment area and capturing the smoke generated during treatment.

The capture device 110 is fluidly coupled to the smoke evacuation device 114 to draw a vacuum at the treatment area, which helps to reduce smoke plumes by encapsulating the treatment area and capturing the smoke generated during treatment.

The capture device 110 may define apertures 126 configured to direct fresh air flow toward the treatment area during the evacuation of the smoke, which can help cool the treatment area and provide a selected fluid flow at or near the treatment area to direct the smoke in a predetermined path toward the smoke evacuation device. The filter 118 in at least a portion of the flow path is configured to capture at least a portion of the particular matter during the treatment, which helps to reduce the amount of smoke generated during treatment and improve overall performance and efficiency.

The maximum amount of smoke that can be captured by the capture device 110 before it becomes useful to empty or replace the filter 118 will depend on several factors, including the size and efficiency of the filter 118, the volume of smoke generated during treatment, and the duration of the procedure. In general, the filter 118 should be replaced after each treatment procedure or when it becomes saturated with smoke or when it functionally reduces the flow rate of air through the capture device 110. The capture device 110 can be adjusted to accommodate different sizes or shapes of the radiation emitting portions 113 of various treatment devices 112. This can be accomplished by designing the capture device 110 with interchangeable components or by using modular systems that allow for customization.

Evacuation Device: a) The evacuation device is a useful component of the smoke plume capture system 100 that removes captured smoke from the treatment area 106 and directs it away from the patient and medical personnel. This device plays a valuable role in ensuring the safety and comfort of those involved in the treatment procedure by effectively removing hazardous fumes generated during radiation therapy or other medical treatments.

b) The evacuation device 114 may be configured to work with various types of smoke plume capture devices 110, allowing for flexibility in selecting the best option for a particular application or treatment setting. This compatibility ensures that the system can accommodate different shapes and sizes of not just radiation emitting portions 113 found in various treatment devices 112, but also various evacuation devices 114, enhancing its adaptability and usefulness.

c) One functional aspect of the evacuation device 114 is its ability to efficiently remove captured smoke from the capture device 110 without causing discomfort or distress to the patient. This may involve utilizing a vacuum pump or other mechanical components that effectively draw smoke through the system, removing it from the treatment area 106 and preventing any potential health risks associated with inhalation of hazardous fumes.

d) The evacuation device 114 is typically configured to be user-friendly, allowing for easy operation by medical personnel during a treatment procedure. This may involve incorporating features such as adjustable suction levels or control handles that enable operators to effortlessly manage the system and ensure optimal performance. Additionally, the device should be ergonomically configured to minimize strain on the operator and facilitate comfortable handling throughout the procedure.

e) To effectively remove captured smoke from the treatment area 106, the evacuation device 114 may incorporate various filtration systems that help to purify the air before expelling it from the system. These filters 118 may be constructed from materials such as foam or fibers that are capable of trapping and retaining particulate matter within their structure, ensuring a high level of efficiency in capturing hazardous fumes.

f) In addition to its primary function of smoke evacuation, the evacuation device 114 may also be designed with safety features that protect medical personnel from potential exposure to harmful fumes or radiation. This may involve incorporating shielding materials or other barriers that prevent direct contact between the operator and any potentially hazardous substances, further enhancing the overall safety of the treatment procedure.

g) The evacuation device 114 in an embodiment is designed with durability in mind to ensure its longevity and reliability during repeated use. This may involve using high-quality materials that are resistant to wear and tear, as well as incorporating features such as easy-to-clean components or replaceable filters 118 to minimize maintenance requirements and maximize system lifespan.

h) Finally, the evacuation device 114 in an embodiment is designed with flexibility in mind to accommodate different treatment settings and application requirements. This may involve offering a range of sizes or configurations that can be customized to fit specific needs or integrate with various types of smoke plume capture devices 110. By providing this level of adaptability, the system can be tailored to meet the unique demands of each individual treatment procedure, enhancing its overall effectiveness and safety.

Filter in the Flow Path of the Capture Device: The filter 118 in the flow path of the smoke plume capture device plays a useful role in ensuring the efficient removal of particulate matter generated during treatment procedures. This component is configured to capture at least a portion of the particulate matter emitted as smoke by the radiation-emitting portion 113 of the treatment device 112, thereby reducing the amount of smoke present in the surrounding environment. The filter 118 may be constructed from various materials such as foam, fibers, or other porous materials that are capable of trapping and retaining particulate matter within their structure.

The design and efficiency of the filter 118 will depend on several factors, including the size and efficiency of the filter 118, the volume of smoke generated during treatment, and the duration of the procedure. In general, the filter 118 should be replaced after each treatment procedure or when it becomes saturated with smoke or when it functionally reduces the flow rate of air through the capture device. The use of a high-quality filter 118 is useful for ensuring proper filtration and minimizing the risk of exposure to harmful particulate matter for both medical personnel and patients.

In addition to its primary function of capturing particulate matter, the filter 118 may also be designed with additional features to optimize performance and user experience. For example, the filter 118 may include a specific material or design that optimizes particle capture efficiency or provides an adjustable flow rate to accommodate different treatment devices 112 or treatment areas 106. The filter 118 may also incorporate safety features such as warning indicators or alarms to alert users when it is time to replace the filter 118 or when it has reached maximum capacity.

The apertures 126 in the capture device 110 contribute to directing fresh air flow towards the treatment area 106 during smoke evacuation, which helps to cool the treatment area 106 and provides a selected fluid flow at or near the treatment area 106 to direct the smoke in a predetermined path toward the smoke evacuation device 114. The design of these apertures 126 is configured to enhance the performance and efficiency of the treatment device 112.

By creating a vacuum at the treatment area 106, the apertures 126 draw in fresh air from surrounding areas, which helps to maintain a suitable environment for the treatment procedure while also reducing the amount of smoke generated during the process. This design feature is particularly beneficial for certain types of treatments that require cooling or controlled fluid flow near the treatment area 106, as it can help to minimize discomfort or adverse reactions for the patient while improving the overall performance and efficiency of the treatment device 112.

However, proper precautions may be taken to ensure that the fresh air flow is properly filtered and cleaned before entering the treatment area 106 to prevent the introduction of external contaminants into the system.

In summary, the apertures 126 in the capture device 110 serve as a useful feature that can enhance the performance and efficiency of the treatment device 112 by reducing smoke generation and providing a controlled fluid flow near the treatment area 106 during smoke evacuation.

The treatment portion 120 of the smoke plume capture device 110 is a useful component that plays a valuable role in effectively capturing and removing smoke generated during medical procedures. This section of the device is configured to surround the radiation emitting portion 113 of the treatment device 112, which may include laser devices, broadband light devices, hyfrecator devices, or other similar equipment. The capture device 110 can be constructed from various materials such as plastics, metals, or ceramics, and its material selection should take into account properties such as durability, resistance to heat and radiation, and transparency to visible light if functional for visualization of the treatment area 106.

The treatment portion 120 of the capture device 110 is attached to both the treatment device 112 and the smoke evacuation device 114 through a specific design or configuration that allows for fluid coupling between the devices. This ensures a secure and airtight seal around the radiation emitting portion 113 while also enabling single-hand operation of the treatment device 112. The capture device 110 can be adjusted to accommodate different sizes or shapes of the radiation emitting portions 113 of various treatment devices 112, which may involve designing the capture device 110 with interchangeable components or using modular systems that allow for customization.

The capture device 110 is fluidly coupled to the smoke evacuation device 114 through tubing 115 or other components to create a seamless flow of air and smoke between the devices. This allows the capture device 110 to draw a vacuum at the treatment area 106 and direct fresh air flow toward the treatment area 106 during smoke evacuation, which may cool the treatment area 106 and provide a selected fluid flow at or near the treatment area 106 to direct the smoke in a predetermined path toward the evacuation device 114. The capture device 110 includes a filter 118 in at least a portion of the flow path, such that the filter 118 is configured to capture at least a portion of the particulate matter generated during the treatment.

The evacuation device 114 removes captured smoke from the capture device 110 through a specific design or configuration that allows for efficient airflow and particulate matter removal. This may involve using vacuum pumps, filters 118, or other components to effectively remove the smoke from the system. The filter 118 in the flow path of the capture device 110 works to capture particulate matter by trapping and retaining the particles within its structure. The type of filter 118 used will depend on the specific application and requirements for capturing particulate matter.

The apertures 126 in the capture device 110 are configured to direct fresh air flow toward the treatment area 106 during smoke evacuation, which may help to cool the treatment area 106 and provide a selected fluid flow at or near the treatment area 106 to direct the smoke in a predetermined path toward the evacuation device 114. However, it is prudent to take caution when introducing external contaminants into the system to ensure proper filtration and cleanliness of the fresh air flow.

Coupling Portion of the Capture Device: The coupling portion 124 of the capture device 110 is a useful component that connects the smoke plume capture device 110 to both the treatment device 112 and the smoke evacuation device 114. This section ensures a secure and airtight seal around the radiation emitting portion 113, allowing for efficient capture of smoke generated during treatment. The design of the coupling portion 124 may be carefully considered to accommodate different sizes or shapes of the radiation emitting portions 113 of various treatment devices 112 while maintaining proper filtration and flow rates.

To achieve this, the capture device 110 can be designed with interchangeable components or modular systems that allow for customization. The materials used in constructing the coupling portion 124 should possess durability, resistance to chemicals and radiation, and flexibility to accommodate different shapes and sizes of treatment devices 112. Suitable materials may include elastomeric materials, high-density polyethylene (HDPE), polytetrafluoroethylene (PTFE), or silicone.

The coupling portion 124 should be attached to the treatment device 112 and smoke evacuation device 114 through a specific design or configuration that allows for fluid coupling between the devices. This may involve connecting tubing 115 or other components to create a seamless flow of air and smoke between the devices. The capture device 110 can define apertures 126 configured to direct fresh air flow toward the treatment area 106 during evacuation of the smoke, which may cool the treatment area 106 and/or provide a selected fluid flow at or near the treatment area 106 to direct the smoke in a predetermined path toward the smoke evacuation device 114.

The filter 118 in at least a portion of the flow path should be configured to capture at least a portion of the particular matter during the treatment. Additionally, or alternatively, the smoke evacuation device 114 may be configured to capture at least the particulate matter of the smoke generated during the treatment.

While the disclosure has been described in connection with what is presently considered to be the most practical and preferred embodiments, it is to be understood that the disclosure is not to be limited to the disclosed embodiments, but on the contrary, is intended to cover various modifications and equivalent arrangements included within the spirit and scope of the appended claims, which scope is to be accorded the broadest interpretation so as to encompass all such modifications and equivalent structures as permitted under the law. Furthermore, it should be understood that while the use of the word preferable, preferably, or preferred in the description above indicates that feature so described may be more desirable, it nonetheless may not be necessary and any embodiment lacking the same may be contemplated as within the scope of the disclosure, that scope being defined by the claims that follow. In reading the claims it is intended that when words such as “a,” “an,” “at least one” and “at least a portion” are used, there is no intention to limit the claim to only one item unless specifically stated to the contrary in the claim. Further, when the language “at least a portion” and/or “a portion” is used the item may include a portion and/or the entire item unless specifically stated to the contrary.

What is claimed is:

1. A smoke plume capture device, comprising:
a treatment portion having a sidewall extending from a distal end that is configured to contact a surface of a treatment area at a proximal end, wherein the treatment portion defines a treatment cavity, wherein the sidewall defines a plurality of venting apertures between the distal end and the proximal end;
a coupling portion extending from the proximal end of the treatment portion, wherein the coupling portion is configured to removably couple to a treatment device; and
an evacuation portion defining a lumen fluidly coupled to the treatment cavity, wherein the evacuation portion is configured to removably and fluidly couple to an evacuation device configured to draw fresh air from outside of the treatment area through the plurality of venting apertures, across the treatment area, and out the lumen of the evacuation portion.

2. The smoke plume capture device of claim 1, wherein the treatment portion comprises an elastomeric material or a silicone material, wherein the distal end of the treatment portion is configured to seal against the surface of the treatment area.

3. The smoke plume capture device of claim 1, wherein the treatment portion comprises a material transparent to at least a portion of radiation in the visible spectrum.

4. The smoke plume capture device of claim 1, wherein the treatment portion comprises a material opaque to radiation in the ultraviolet spectrum.

5. The smoke plume capture device of claim 1, wherein at least one of the plurality of venting apertures defines a channel extending from an exterior surface of the sidewall to an interior surface of the sidewall at a trajectory toward the surface of the treatment area.

6. The smoke plume capture device of claim 1, wherein at least one of the plurality of venting apertures defines a channel extending from an exterior surface of the sidewall to an interior surface of the sidewall at a trajectory configured to generate a circular flow path through the treatment cavity.

7. The smoke plume capture device of claim 1, wherein the treatment device comprises a handheld device having a radiation emitting portion, and wherein the coupling portion is configured to removeably couple to the radiation emitting portion.

8. The smoke plume capture device of claim 7, wherein the treatment device is configured to emit radiation having a selected wavelength range toward the surface of the treatment area, and wherein the treatment portion is opaque to at least a portion of the selected wavelength range of the emitted radiation.

9. The smoke plum capture device of claim 1, wherein the evacuation portion comprises a sidewall defining the lumen and extending from a distal end to a proximal end, wherein the distal end of the sidewall of the evacuation portion is coupled to the sidewall of the treatment portion such that the lumen is fluidly coupled to the treatment cavity.

10. The smoke plum capture device of claim 1, wherein the evacuation portion comprises a filter disposed within at least a portion of the lumen, wherein the filter is configured to remove at least a portion of particulate matter from a fluid drawn from the treatment cavity.

11. A smoke plume capture device for coupling to a treatment device and a smoke evacuation device, comprising a capture device that surrounds a radiation emitting portion of the treatment device, wherein the capture device is fluidly coupled to the smoke evacuation device to draw a vacuum at the treatment area, wherein the capture device defines apertures configured to direct fresh air flow toward the treatment area to cool the treatment area and direct smoke from the treatment area in a predetermined flow path toward the smoke evacuation device, wherein the capture device comprises a filter in at least a portion of the flow path, wherein the filter is configured to capture at least a portion of a particulate matter of the smoke.

12. The smoke plume capture device of claim 11, wherein the materials used for the construction of the capture device comprise elastomeric materials, high-density polyethylene (HDPE), polytetrafluoroethylene (PTFE), or silicone.

13. The smoke plume capture device of claim 12, wherein the capture device is configured to provide an airtight seal around the radiation emitting portion of the treatment device.

14. The smoke plume capture device of claim 11, wherein the capture device is configured to be adjusted to accommodate different sizes or shapes of the radiation emitting portions of various treatment devices.

15. A system for capturing particulates produced at a surface of a treatment area in response to incident radiation, comprising:
a treatment device configured to direct radiation having a selected wavelength range toward a treatment area;
a smoke evacuation device configured to draw smoke away from the treatment area along a flow path and contain or filter at least one constituent from the smoke;
a smoke plume capture device coupled to the treatment device and the smoke evacuation device, wherein the capture device surrounds a radiation emitting portion of the treatment device, wherein the capture device defines a plurality of apertures configured to direct fresh air flow toward the treatment area during evacuation of the smoke, and wherein the capture device comprises a filter disposed in at least a portion of the flow path and configured to capture at least a portion of the at least one constituent from the smoke.

16. The system of claim 15, wherein the materials used for construction of the smoke plume capture device comprise elastomeric materials, high-density polyethylene (HDPE), polytetrafluoroethylene (PTFE), or silicone.

17. The system of claim 15, further comprising multiple smoke plume capture devices that are independently controlled to work with multiple treatment devices simultaneously.

18. The system of claim 15, wherein the capture device is configured to work with different types of radiation emitting portions by modifying the filter or other components of the capture device to ensure proper filtration and capture of the specific type of smoke generated by the treatment device.

19. The system of claim 15, wherein the capture device is transparent to visible light and allows an operator to visualize the treatment area while capturing the smoke produced during treatment.

20. The system of claim 15, further comprising a control module that regulates the operation of at least one of the capture device, the treatment device, and evacuation device to optimize performance and efficiency during treatment.
